(19) United States
(12) Patent Application Publication
(10) Pub. No.: US 2007/0140058 A1
(43) Pub. Date: Jun. 21, 2007

(54) Method and system for correcting transducer non-linearities

(75) Inventors: Jason D. McIntosh, Weston, FL (US); Peter M. Pavlov, Plantation, FL (US); Mikhail U. Yagunov, Pompano Beach, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/283,616

(22) Filed: Nov. 21, 2005

(51) Int. Cl. B06B 1/06

(52) U.S. Cl. 367/140

(57) ABSTRACT

The embodiments of the invention concern a method (400) and system (100) for modeling transducer non-linearities. The method can include converting (402) a transducer signal to a displacement signal that is proportional to a transducer cone displacement, and applying (404) a correction to the displacement signal. The transducer signal can be one of an input signal to the transducer (102) or an acoustic output signal of the transducer. The method can account for at least one mechanical transducer non-linearity which can be a cone excursion, a diaphragm stiffness, or a diaphragm displacement. The method can account for at least one acoustic transducer non-linearity which can account for an acoustic jetting out of a port. The system can further include a sensor coupled to said transducer for physically measuring a cone displacement.

### FIELD

This invention relates in general to methods and systems that transmit and receive audio communication, and more particularly, speakerphone systems .

### BACKGROUND

In recent years, portable electronic devices, such as cellular telephones and mobile communication devices, have become commonplace. Many of these devices include a high-audio transducer for providing speakerphone operation. The single transducer is usually of a small size to allow for compact placement within the mobile device. Due to their small size, the transducer is generally limited in providing wide band audio fidelity. For example, low frequency sounds require sufficient speaker cone displacement to produce the low frequency acoustic pressure wave. In addition, high frequencies are often phase modulated and compressed by the high energy low frequency signals. These are both non-linear effects. For example, an audio signal with significant low frequency signal can cause large cone excursions which cause the diaphragm stiffness to increase. High frequency signals within the audio signal can be compressed as the cone is pushed out to maximum excursion. Additionally, high frequency signals generated when the cone is at maximum excursion take less time to travel to a listener than high frequency signals generated when the cone is at a maximum negative displacement. This effect produces a phase modulation of high frequencies by low frequencies. Consequently, moving coil speakers in small size transducers have mechanical and acoustic nonlinearities that cause them to produce distorted output and reduce the overall audio quality.

Mobile communication devices that support speakerphone operation generally include an echo suppressor for suppressing an echo signal. For example, during speakerphone mode, a microphone of the speakerphone may unintentionally capture the acoustic output of the speakerphone. This can be the case when the speakerphone is of a significant volume level to be fed back into the phone through the microphone and sent over the communication network to the talker. The talker can potentially hear their own voice which can be distracting. To mitigate such problems, an echo suppressor attempts to predict an echo signal from the talker signal and suppress the echo signal captured on the microphone signal. For example, the talker signal is generally considered the audio input signal to the transducer, which is the signal the echo suppressor generally uses for predicting the echo. The audio input signal can be fed to the transducer to produce an acoustic output signal. The acoustic output signal generally undergoes a linear transformation as a result of the acoustic environment as the sound pressure wave propagates from the transducer to the microphone. The echo suppressor generally employs an adaptive linear filter for estimating the environment that can generally be represented as a linear transformation of the acoustic output signal. Because the echo is generally a time shifted and scaled version of the acoustic output signal, the echo suppressor is generally able to determine a linear transformation of the echo environment.

Echo suppressor performance degrades when the adaptive linear filter attempts to model a non-linear transformation. The non-linear transformation can come from the environment, or from the source that generated the acoustic output signal. For example, a small speaker introduces distortions due to mechanical non- linearities, such as those common with large cone excursions including stiffness and inductance effects, and acoustic non-linearities, such as those due to speaker porting arrangements. A speaker port can be a vent or opening which allows for the movement of air from the speaker cone for producing an acoustic pressure wave. Small speakers which are embedded within a communication device can require side ports or front ports for releasing the acoustic pressure. As the pressure wave passes through the port, the pressure wave can undergo compression which introduces non- linear deviations in the pressure wave at the port boundaries. The port placement, size, and arrangement, can introduce acoustic non-linearities onto the resulting acoustic output signal. An echo suppressor based on modeling a linear transformation will degrade in performance due to these non-linearities, and may be unable to adequately suppress the echo signal. Nonlinear mechanisms can occur in the path from the source (transducer) input to the sensor (microphone), and nonlinear estimators can be used to estimate the nonlinear parts of the path. For example, a neural net algorithm can be trained to learn non-linearities within the path. Non-linear estimators generally form models directly from the path data, and not generally from the mechanics of a transducer or from the acoustic porting arrangement.

### SUMMARY

The present embodiments of the invention concern a method and system for modeling transducer non-linearities. The method can include converting a transducer signal to a displacement signal, and applying at least one correction to the displacement signal. The displacement signal can be proportional to a transducer cone displacement. The correction can include applying at least one distortion to the displacement signal which can be a memory-less and nonlinear operation. The distortion can also be applied as a fixed or adaptive process using a convergence error of an adaptation process. For example, the adaptation process can be the Least Mean Squares (LMS) algorithm in an echo suppressor.

In one aspect, the transducer signal can be an input signal to the transducer, or an acoustic output signal of the transducer. In another aspect, a correction can include accounting for at least one mechanical transducer non-linearity, which can produce a distorted displacement signal. The mechanical transducer non-linearity can be a transducer cone excursion, a diaphragm stiffness, or a diaphragm displacement. The method can further include applying a time derivative operator to the displacement signal for producing a velocity signal, accounting for at least one acoustic transducer non-linearity to produce a distorted velocity signal, and converting the distorted velocity signal into an acceleration signal. An acoustic transducer non-linearity can include non-linear acoustic jetting through at least one transducer port. For example, the acceleration signal can be an estimate of the sound pressure level produced by the transducer. In one arrangement, the acceleration signal can be fed to the echo suppressor for removing a transducer signal from a microphone signal.

An embodiment for modeling transducer non-linearities can concern a method for echo suppression. The method can include converting a transducer signal to a displacement signal, applying at least one correction to the displacement signal to produce a distorted signal, and using the distorted signal as an input for echo cancellation for suppressing an echo from a microphone input signal. The displacement signal can be proportional to a transducer cone displacement. The correction can produce the distorted signal which suppresses at least one non-linear component of the transducer signal. In one aspect, the distorted signal facilitates a convergence of the echo cancellation by suppressing non-linear components. A convergence error of the adaptation process which the echo cancellation can be used during the correction.

The present embodiments also concerns a system for modeling transducer non-linearities for suppressing an echo. The system can include a displacement unit for converting an input signal to a displacement signal, and a first non-linear estimator for modeling at least one transducer non-linearity. The input signal can be a digital voltage or an analog voltage applied to the input of the transducer. The displacement signal can be proportional to a transducer cone displacement. The non-linear estimator can also apply at least one correction to the displacement signal. For example, the non-linear estimator can apply a memory-less non-linear distortion to the displacement signal which takes transducer non-linearities into account. In one arrangement, the distortion unit can receive the displacement signal from the displacement unit to produce a distorted displacement signal. The system can further include a transducer for producing an acoustic signal in response to the input signal, a microphone for converting the acoustic signal into an audio signal, and an echo suppressor, responsive to said distorted signal, for suppressing a linear component of the audio signal. For example, the audio signal can include a linear component that is a linear function of the acoustic signal and a non-linear component which is a non-linear function of the transducer. For instance, the transducer can impart at least one non-linear component onto said acoustic signal related to at least one transducer non-linearity. The distorted signal compensates for at least one transducer non-linearity thereby facilitating a convergence of the echo suppressor.

In one arrangement, the non-linear estimator can account for at least one mechanical transducer non-linearity, which can be a transducer cone excursion, a diaphragm stiffness, or a diaphragm displacement. The system can further include a differential operator for converting the distorted displacement signal into a velocity signal, and a second non-linear estimator for applying a second distortion to said velocity signal, and for converting said distorted velocity signal into an acceleration signal. The second distortion can model at least one acoustic transducer non-linearity for producing a distorted velocity signal. For example, an acoustic transducer non-linearity can be a non-linear acoustic jetting through at least one transducer port and which is proportional to an instantaneous acoustic velocity.

In yet another arrangement, the system can further include a spectral whitener for flattening a spectrum of said distorted signal. For example, the first and second non-linear estimator can provide significant spectral shaping which can affect the convergence of an adaptive process within the echo suppressor. The spectral whitener can receive the distorted signal from one of the non-linear estimators and provide a whitened signal to an input of said echo suppressor. Accordingly, the first non-linear estimator and said second non-linear estimator can receive a convergence error from the echo canceller and adapt using a gradient search algorithm.

The system can also include a sensor coupled to said transducer for physically measuring a cone displacement. For example, the displacement unit can convert an input signal to a displacement signal using the physically measured cone displacement.

### BRIEF DESCRIPTION OF THE DRAWINGS

FIG. 1 is a block diagram of an echo suppression system in accordance with the present invention.

FIG. 2 is a more detailed block diagram in accordance with the present invention.

FIG. 3 is a transducer in accordance with the present invention.

FIG. 4 is a set of transducer compression curves in accordance with the present invention.

FIG. 5 is a method for correcting transducer non-linearities in accordance with the present invention.

### DETAILED DESCRIPTION

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present embodiments concern a method and system for correcting transducer non-linearities for use with an echo suppressor. The method can include converting a transducer signal to a displacement signal that is proportional to a transducer cone displacement. Memory-less nonlinear distortions which take transducer nonlinearities into account can be applied to the displacement signal. The distorted displacement signal can be converted to a velocity signal, and fed to a second memory-less nonlinear distortion section that takes nonlinear acoustic jetting through ports into account. The distorted velocity signal can be converted to an acceleration signal for providing a good estimate of the sound pressure level (SPL) produced by the transducer. The acceleration signal can be fed into a LMS based echo suppressor to remove the transducer signal from a microphone signal.

In one arrangement, the present embodiments of the invention provide for the modeling of transducer non-linearities. The method can include converting a transducer signal to a displacement signal, and applying at least one correction to the displacement signal. The displacement signal can be proportional to a transducer cone displacement. The correction can include applying at least one distortion to the displacement signal which can be a memory-less and nonlinear operation. The distortion can also be applied as a fixed or adaptive process using a convergence error of an adaptation process.

In one aspect, a correction can include accounting for at least one mechanical transducer non-linearity. The mechanical transducer non-linearity can be a transducer cone excursion, a diaphragm stiffness, or a diaphragm displacement. In another aspect, a correction can include accounting for at least one acoustic transducer non-linearity to produce a distorted velocity signal, and converting the distorted velocity signal into an acceleration signal. An acoustic transducer non-linearity can include non-linear acoustic jetting through at least one transducer port. Non-linear jetting can be the acceleration of air through a port which disrupts a continuous movement of air through the port. In one arrangement, the acceleration signal can be fed to the echo suppressor for removing a transducer signal from a microphone signal.

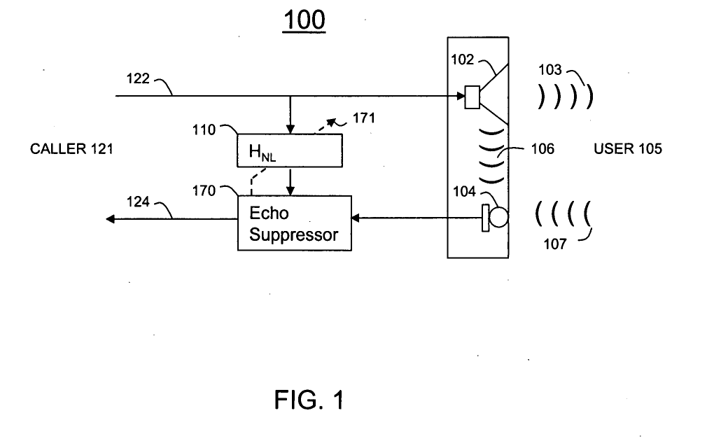

In FIG. 1 a system 100 for correcting transducer non-linearities in an echo suppression system is shown. The system 100 can reside within a mobile communication device that receives audio data from a caller 121 over a communication network. The mobile device can receive an audio signal on an input line and play the audio signal 122 out of a transducer 102 to a user 105 of the mobile communication device. The transducer 102 can be a high-output audio speaker that can produce an acoustic signal 103 during a speakerphone mode. The transducer 102 can output the audio signal 122 at a sufficiently high volume level such that a microphone 104 can capture the acoustic signal 103 and send it back to the caller 121. The microphone 104 can capture a signal which can be a combination of a direct path acoustic signal 106 and an echo signal 107. The direct path signal 106 can be an acoustic signal traveling directly from the transducer 102 to the microphone 104. The echo signal 107 can be a reverberation of the acoustic signal 103 within the user environment 105. For example, the acoustic signal 103 can reflect off objects within the user environment that can be captured by the microphone 104.

The system 100 can include an echo suppressor 170 for suppressing the direct path signal 106 and the echo signal 107. The echo suppressor 170 can suppress echo to produce an echo suppressed signal 124 such that the caller 121 does not hear an echo of their voice when they are speaking. The echo suppressor 170 can employ a Least Mean Squares (LMS) algorithm for modeling a linear transformation of the user environment. The echo suppressor 170 can adequately suppress an echo when the signal is sufficiently representative of a linear transformation of the original acoustic signal 103. The echo suppressor 170 can also produce a convergence error 171 for providing a performance measure.

Briefly, the echo suppressor 170 attempts to model a linear transformation between the signal received at the microphone 104 and the audio signal 122 provided as input to the transducer 102. The audio line 122 fed to the transducer 102 can also be considered the input signal. The convergence error 171 reveals how well the echo suppressor 170 is capable of modeling the environment, and accordingly, how well the echo suppressor 170 can suppress the echo. A low convergence error can generally imply good modeling performance whereas a high convergence error can generally imply poor modeling performance. A low convergence error can also be the result of minimal echo in the environment, or of a minimal amplitude direct path signal. A minimal amplitude direct path signal can exist when the transducer 102 is properly insulated from the microphone 104 to avoid any high audio leakage.

Accordingly, significant direct path signal contributions can exist when the transducer 102 is not adequately sealed off from the microphone input 104 For example, a transducer 102 that is not properly sealed can leak sound pressure waves from the transducer housing arrangement to the microphone path.

The majority of the nonlinear mechanisms produced in transducers are related to the speaker's diaphragm displacement, not the voltage into the speaker. This makes predicting a nonlinear correction term significantly more difficult for nonlinear estimators that learn directly from the path data. Accordingly, taking into account transducer attributes can lessen the difficulty of modeling a non-linear transformation during learning or adaptation.

Accordingly, the system 100 can include a non-linear corrector 110 for modeling non-linearities within the system 100. For example, speaker distortion (particularly for dispatch radio/speakerphone applications) can be dominated by nonlinearities produced by and directly dependent upon large cone excursions. The nonlinearities in the transducer 102 output can reduce echo cancellation performance which can limit dispatch radio operation to single-duplex. The non-linear corrector 110 can provide a means for effectively dealing with the transducer nonlinearities to improve echo suppression performance. The non-linear corrector 110 can also apply at least one correction that is a memory-less and nonlinear operation. The transducer non-linearities can be both mechanical and acoustic.

Briefly, the non-linear estimator 110 can improve the ability for nonlinear adaptive algorithms to model nonlinear behavior. The echo suppressor 170 can more accurately model a linear transformation of the acoustic signal 103 when the non-linear corrector 110 removes (or suppresses) non-linearities on the acoustic signal 103. The non-linear corrector 110 can incorporate a convergence error 171 of an adaptation process within the echo suppressor 170 that can be a fixed or adaptive process. For instance, the transducer 102 can impart non-linear mechanical effects onto the acoustic signal 103 due to speaker cone displacement, stiffness, and inductance. In another example, air ports or leaks within the mobile communication device can induce acoustic non-linearities such as those due to changes in sound pressure or velocity. In one arrangement, the non-linear corrector 110 can incorporate these mechanical and acoustic non-linear attributes to improve linear modeling behavior within the echo suppressor 170.

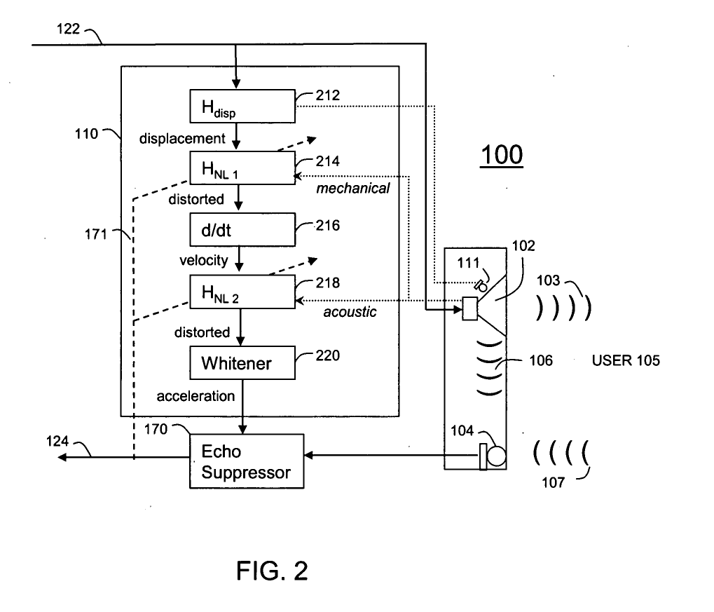

Referring to FIG. 2, a more detailed representation of the non-linear corrector 110 within the system 100 is shown. The non-linear corrector 110 can include a displacement unit 212, a first non-linear estimator 214, a differential operator 216, a second non-linear estimator 218, and a whitener 220. The components 212 to 220 of the non-linear corrector 110 can be in a sequential order and aligned between the audio line path 122 and an input to the echo suppressor 170 as seen in FIG. 2, or in the arrangements as contained within the scope of the claims herein. Briefly, the displacement unit 212 describes the transducer's physical diaphragm displacement for various sound pressure levels over frequency. In one arrangement, a laser can be used to measure a linear transfer function between the transducer voltage and transducer displacement. In another arrangement, a second sensor 111 can be placed close to, or in contact, with the cone of the transducer 102 for measuring the displacement.

The first non-linear estimator 214 can use the displacement estimate to predict a non-linear transfer function H_{NL1} that describes non-linear distortions as a result of diaphragm displacement. Consequently, the first non-linear estimator 214 accounts for the mechanical transducer 102 non-linearities and produces a distorted displacement signal. In one arrangement, the differential operator 216 can incorporate acoustic non-linearities and convert the distorted displacement signal into an acoustic velocity signal. A second non-linear estimator 218 can use the acoustic velocity estimate to predict a second non-linear transfer function H_{NL2} that describes non-linear distortions as a result of acoustic jetting through ports. Consequently, the second non-linear estimator 218 accounts for acoustic transducer 102 non-linearities and produces a distorted velocity signal.

The velocity signal can be fed to a whitener 220 that can apply a compensatory equalization to account for spectral shaping at the displacement unit 212 and the differential operator 216. Recall, the displacement unit 212 applies a displacement distortion to prepare the displacement signal for the first non-linear estimator 214. The differential operator 216 applies a velocity distortion to prepare the velocity signal for the second non-linear estimator 218. Briefly, the first non-linear estimator 214 and second non-linear estimator 218 are employed to predict mechanical and acoustic non-linear distortions generated by the transducer, respectively. Consequently, the velocity signal can be whitened to restore the audio signal from these distortions applied at the displacement unit 212 and the differential operator 216. The whitener 220 can produce an acceleration signal that can be input to the echo suppressor 170, which can facilitate a convergence of the echo canceller. acceleration signal can provide an estimate of the sound pressure level produced by the transducer. The first and second non-linear estimators can account for transducer non-linearities and produce a whitened acceleration signal substantially devoid of non-linearities. Accordingly, the echo suppressor 170, can be capable of modeling the remaining linear portion of the echo signal using standard LMS based techniques.

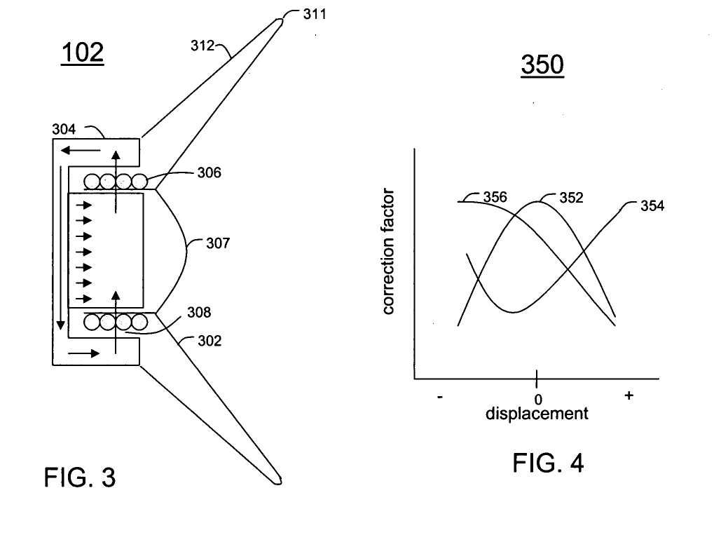

Referring to FIG. 3, a speaker 102, as is known in the art, is shown for illustrating the sources of mechanical non-linearities in the transducer 102 of FIG. 1. The transducer 102 converts an electrical signal, such as one expressed as a voltage, to an acoustic signal, such as one expressed in dB as a sound pressure level. The transducer converts an electrical signal to a physical movement of a speaker cone, and in general can be a moving coil speaker such as that shown in FIG. 3. The transducer 102 can include a speaker cone 302, a magnet 304, a voice coil 306, and a dust cap 307. The term diaphragm and cone can be used interchangeably within the context of a small size speaker which generally connects the diaphragm to the dust cap as one moveable unit. In small size speakers, the diaphragm 307 can be structurally fitted to the speaker cone 302 and can include a wire wrap coil 306 for movement within the magnet 304. The speaker cone 302 can be connected using speaker surround 311 to a housing 312. The transducer can exhibit three major nonlinear mechanisms due to large cone excursions which can cause the transducer to distort an output signal.

First, a large cone excursion can cause the voice coil 306 to leave the area of maximum magnetic flux density in the magnetic gap 308. For example, a large voltage swing can produce a large cone excursion causing the force per unit current to decrease, and thus causing the output to no longer be a linear function of the input. Mathematically, the magnet BL motor factor can become a function of displacement x, or BL=BL(x).

Second, a large cone excursion can cause the diaphragm's stiffness to increase. The increase can be due to the diaphragm's roles 311 becoming “unrolled” for large excursions. Accordingly, more force can be required to move the diaphragm 307 a given distance. Again, this stiffness can cause the transducer output to no longer be linearly related to the input. Mathematically the transducer's stiffness k becomes a function of displacement x, or k=k(x).

Third, a large cone excursion can cause the voice coil 306 to move out of the magnetic circuit created by the metal magnetic structure 304. Since the voice coil's inductance is a function of the metal 304 surrounding the voice coil 306, the inductance can become a function of the diaphragm's displacement x, which can produce nonlinear distortion. Mathematically, the inductance L is a function of L, or L=L(x).

The three mentioned transducer mechanical non-linearities can each be represented using a general compression curve. For example, referring to plot 350, a compression curve for cone excursion 352, diaphragm stiffness 354, and magnetic induction 356 is shown. The x-axis represents the diaphragm displacement and the y-axis represents one of the three mechanical non-linearities. Referring to FIG. 2, the displacement unit 212 provides the diaphragm displacement through a linear mapping function. One skilled in the art can appreciate a different compression curve is available for each mechanical non-linearity. For example, the compression curve 354 shown can represent a diaphragm stiffness. For a given audio input 122 voltage level, the displacement unit 212 will map the audio input voltage to a diaphragm displacement.

A non-linear estimator can use one of the compression curves 350 to determine a level of applied correction, or distortion. For example, the first non-linear estimator 214 evaluates a cone excursion factor, a diaphragm stiffness factor, and a magnetic inductance factor using compression curves 352, 354, and 356 for each factor, respectively. The first non-linear estimator 214 looks along the x-axis of a compression curve 350 for the mapped diaphragm displacement, and identifies the associated y-axis point on the compression curve. The y-axis on the compression curve 350 describes the correction factor, or distortion level, to apply to the audio input signal 122 to account for the non-linear behavior of the transducer at the corresponding audio input voltage level. Similarly, the second non-linear estimator 218 evaluates an acoustic factor using its compression curve. For example, the compression curves 350 can relate a mapping between acoustic port sizes and effects on acoustic velocity. For instance, the acoustic jetting through ports can be represented as a compression curve, or function, of the acoustic velocity. The second non-linear estimator 218 can look up an acoustic velocity on the x-axis and identify a corresponding acoustic factor on the y-axis of the compression curve.

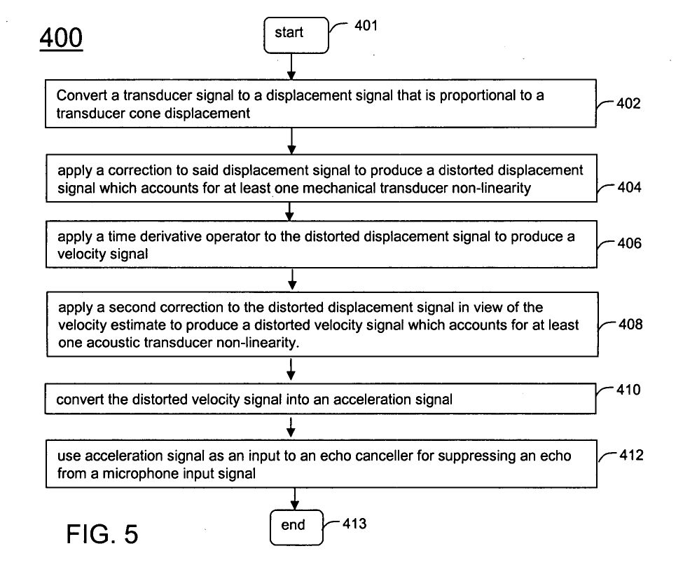

Referring to FIG. 5 a method 400 for correcting transducer non-linearities is shown. When describing the method 400, reference will be made to FIG. 2, 3, and 4 although it must be noted that the method 400 can be practiced in any other suitable system or device. Moreover, the steps of the method 400 are not limited to the particular order in which they are presented in FIG. 4. The inventive method can also have a greater number of steps or a fewer number of steps than those shown in FIG. 4. In one particular example, the method 400 for correcting transducer non-linearities can be included within an echo suppression system.

At step 401, the method 400 can start. At step 402, a transducer signal can be converted to a displacement signal that is proportional to a transducer cone displacement. The transducer signal can be an audio input voltage to a transducer. For example, referring to FIG. 3, the speaker cone 302 undergoes a characteristic displacement for each frequency along a continuum of voltage levels. Accordingly, the displacement can be measured for various voltage levels and frequencies. A laser can be used to measure a linear transfer function H_{disp} between the speaker voltage and the speaker displacement. The linear transfer function H_{disp} can represent a mapping between an input signal and an output displacement signal. For example, referring to FIG. 2, the displacement unit 212 can include the physical speaker displacement measurements and convert the audio signal 122 input into a displacement signal using the mapping. For example, the displacement unit 212 maps a 600 Hz audio input swing of −0.5V to +0.5V to a diaphragm displacement of −0.2 mm to +0.2 mm. In one arrangement, a sensor 111 placed proximal to the transducer 102 measures the displacement as an acoustic wave 103 is being generated by the transducer. The sensor 111 provides the displacement information to H_{disp} 212.

At step 404, a correction can be applied to the displacement signal. For example, referring to FIG. 2, the first non-linear estimator 214 accounts for at least one mechanical transducer non-linearity and produces a distorted displacement signal. As discussed in FIG. 3, the mechanical transducer non-linearities can include a mechanical transducer non-linearity such as a transducer cone excursion, a diaphragm stiffness, or the effects of magnetic induction. The first non-linear estimator 214 includes a non-linear adaptive algorithm that uses the displacement information for modeling the transducer's non-linear mechanical behavior. The non-linear adaptive algorithm distorts the displacement signal as a function of the cone excursion, a function of the stiffness, a function of the magnetic induction in view of the diaphragm displacement using the compression curves 350 of FIG. 4 The first non-linear estimator 214 looks up a cone excursion factor, a diaphragm stiffness factor, and a magnetic induction factor on the corresponding compression curve 350 of FIG. 3. The non-linear adaptive algorithm accordingly predicts the distortions in view of the mechanical factors and compensates the audio signal to account for the transducer non-linearities. The algorithm can be fixed or adaptive, using the convergence error 171 from the echo suppressor 170 in the latter.

The first non-linear estimator 214 converts the speaker voltage to a displacement signal using a memory-less nonlinear corrector to predict the distortions generated by the speaker. A memory based system keeps a history whereas a memory-less system does not keep a history. For example, referring to FIG. 1, H_{NL} 110 can be a memory-less system which only uses the currently available value of the error 171. For instance, the error can be produced on a sample by sample basis or on a frame basis. In contrast, a memory based H_{NL} 110 will use previous values of the error for modeling transducer non-linearities.

The memory-less based approach results in less computation time, with a faster convergence using an adaptive approach. Up until step 404, which includes the processing by the displacement unit 212 and first non-linear estimator 214 of FIG. 2, the non-linearities have only been mechanically based (i.e. speaker motion). However, acoustic non-linearities can also be present. Many acoustic non-linearities in mobile communication devices arise from non-linear acoustic jetting out of small ports. These nonlinearities are related to the instantaneous acoustic velocity, which velocity is proportional to the time derivative of the displacement.

Accordingly, at step 406, a time derivative operator can be applied to the distorted displacement signal for producing a velocity signal. Referring to FIG. 2, the differential operator 216 applies a simple differential operation to convert the distorted displacement signal to a velocity signal. The simple differential operator 216 feeds the velocity estimate into the second nonlinear estimator 218. Nonlinear acoustical distortion is primarily produced by the high amplitude sound waves producing a fluidic jetting from the ports through which the sound passes. These jetting nonlinearities are dependent upon the instantaneous velocity through the ports. Accordingly, the second non-linear estimator 218 converts the displacement estimate to a velocity estimate using another memory-less distortion block to produce the nonlinear contribution from the non-linear acoustic transducer sources

At step 408, a second correction can be applied to the distorted displacement signal in view of the velocity estimate to account for at least one acoustic transducer non-linearity. For example, the non-linear acoustic jetting through at least one transducer port is an acoustic transducer non-linearity that is proportional to an instantaneous acoustic velocity. For example, the second non-linear estimator 218 calculates an instantaneous acoustic velocity from the velocity estimates provided by the differential operator 216, thereby operating on the acoustic velocities for modeling the acoustic nonlinearities. The second non-linear estimator 218 applies a second distortion to the velocity signal to model at least one acoustic transducer non-linearity; for example, a measure of the acoustic jetting in view of the instantaneous velocity.

At step 410, the distorted velocity signal is converted into an acceleration signal. For example, referring to FIG. 2, the second non-linear estimator 218 looks up the acoustic non-linearity factor from the compression curve 350 using the velocity estimate and converts the velocity signal into a distorted velocity estimate. In one arrangement, the velocity signal can be whitened to remove any spectral coloration from processing blocks 212 and 216. For example, referring to FIG. 2, the whitener 220 can equalize spectral shaping as a result of the processing by the displacement unit 212 and differential operator 216 before input to the echo suppressor 170. The echo suppressor 170 employs an LMS algorithm which requires the spectrum to be as ‘white’ as possible. The H_{disp} 212 and d/dt 216 stages provide significant spectral shaping, and so it is desired to add a whitener after the nonlinear stages, just before the echo suppressor using a compensation filter H_{w}˜=1/(H_{disp} d/dt).

At step 412, the acceleration signal can be provided as input to an echo suppressor for suppressing an echo from a microphone input signal. For example, referring to FIG. 2, the whitener 220 can provide the whitened acceleration signal to the echo suppressor 170. The whitened acceleration signal represents a best estimate to the audio input signal 122 accounting for the mechanical and acoustic transducer non-linearities. The displacement unit 212 and differential operator 216 can be adaptive or fixed, with an adaptive approach providing increased convergence performance. For example, the transfer function for 212 and the transfer function for 216 can be measured in place and in advance of the processing. The sensor 111 can measure the transfer function in-situ. Accordingly, the displacement unit 212 and differential operator 216 can adapt. The echo suppressor 170, uses the convergence error 171 as a performance criterion to learn a linear model of the user environment. Accordingly, the first non-linear estimator 214 H_{NL1} and the second non-linear estimator 218 H_{NL2} utilize the convergence error 171 from the echo suppressor 170 to tune their performance. The processing blocks 214 and 218 use the convergence error to learn a non-linear model of their transducer mechanical and transducer acoustic non-linearity, respectively. During adaptation, the first non-linear estimator 214 includes the convergence error during the step of applying a correction to the displacement signal. During adaptation, the second non-linear estimator 216 includes the convergence error during the step of applying a second correction to the velocity signal.

In summary, speaker distortions are dominated by non-linearities produced by and directly dependent upon large cone excursions. By converting the speaker voltage to a displacement signal, the memory-less non-linear corrections applied by the first 214 and second 218 non-linear estimators can predict distortions made by the speaker and correct for the non-linearities. Consequently, the non-linearities within the resulting whitened acceleration signal will be minimal which improves the ability for the echo suppressor to model a linear transformation of the user environment. This can increase echo suppressor performance on the far end. The method 400, described by the processing blocks 212 to 220, provides a means for removing transducer non-linearities when a speaker is driven to produce non-linear distortions due to high volume levels. In the preferred embodiment, the method 400 and system 100 are used within the context of an echo suppressor to increase the convergence of the adaptation system with the echo suppressor. For example, referring to FIG. 2, the microphone 104 picks up the distorted acoustic output signal 103 from the speaker 102 which is input to the echo suppressor 170. The whitener 220 provides a reference signal to the echo suppressor 170 which has been compensated for the transducer mechanical and acoustic non-linearities. The reference signal is the whitened acceleration signal which represents a best estimate to the audio signal 122 without transducer non-linearities. The echo suppressor 170, models a linear transformation between the whitened acceleration signal and the microphone input signal, which represents the user environment 105. The processing blocks 212 to 220 have removed the transducer non-linearities resulting in an increased adaptation performance for modeling the linear transformation by the echo suppressor 170.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for modeling transducer non-linearities, comprising
converting a transducer signal to a displacement signal that is proportional to a transducer cone displacement; and
applying a correction to said displacement signal,
wherein said transducer signal can be one of an input signal to said transducer or an acoustic output signal of said transducer.

2. The method of claim 1, wherein said correction comprises:
accounting for at least one mechanical transducer non-linearity for producing a distorted displacement signal.

3. The method of claim 2, wherein a mechanical transducer non-linearity is at least one of a transducer diaphragm excursion, a diaphragm stiffness, or a diaphragm displacement.

4. The method of claim 3, further comprising:
applying a time derivative operator to said distorted displacement signal for producing a velocity signal; and
apply a second correction to said velocity signal.

5. The method of claim 4, wherein said second correction comprises:
accounting for at least one acoustic transducer non-linearity for producing a distorted velocity signal.

6. The method of claim 5, wherein an acoustic transducer non-linearity includes non-linear acoustic jetting through at least one transducer port.

7. The method of claim 6, further compromising:
applying a whitener to said distorted velocity signal; and
converting said distorted velocity signal into an acceleration signal.

8. The method of claim 7, wherein said acceleration signal is an estimate of the sound pressure level produced by said transducer.

9. The method of claim 1, wherein said applying at least one correction is one of a fixed or adaptive process using a convergence error of an adaptation process during said correction, and at least one correction is a memory-less and nonlinear operation.

10. A method for echo suppression, comprising
converting a transducer signal to a displacement signal which is proportional to a transducer cone displacement;
applying at least one correction to said displacement signal to produce an acceleration signal for suppressing at least one non-linear component of said transducer signal; and
using said acceleration signal as an input to for echo cancellation for suppressing an echo from a microphone input signal,
wherein said acceleration signal facilitates a convergence of the echo cancellation.

11. A system for suppressing transducer non-linearities, comprising
a displacement unit for converting an input signal to a displacement signal that is proportional to a cone displacement of a transducer; and
at least one non-linear estimator for modeling at least one transducer non-linearity and applying at least one correction to said displacement signal,
wherein at least one non-linear estimator receives said displacement signal from said displacement unit to predict at least one distortion generated by said transducer for producing a distorted signal.

12. The system of claim 11, further comprising:
a transducer for producing an acoustic signal in response to said input signal, said transducer imparting at least one non-linear component onto said acoustic signal. related to at least one transducer non-linearity;
a microphone for converting said acoustic signal into an audio signal, said audio signal including a linear component which is a linear function of said acoustic signal and a non-linear component which is a non-linear function of said transducer; and
an echo suppressor, responsive to said distorted signal, for suppressing said linear component of said audio signal received by said microphone.

13. The system of claim 12, wherein said distorted signal compensates for at least one transducer non-linearity thereby facilitating a convergence of the echo suppressor.

14. The system of claim 11, wherein said non-linear estimator applies a memory-less non-linear distortion to the displacement signal that takes transducer non-linearities into account.

15. The system of claim 11, wherein said non-linear estimator accounts for at least one mechanical transducer non-linearity that is at least one of a transducer cone excursion, a diaphragm stiffness, or a magnetic induction.

16. The system of claim 11, further comprising:
a differential operator for converting said distorted signal into a velocity signal; and
a second non-linear estimator for applying a second distortion to said velocity signal to model at least one acoustic transducer non-linearity for producing a distorted velocity signal.

17. The system of claim 16, wherein an acoustic transducer non-linearity is a non-linear acoustic jetting through at least one transducer port that is proportional to an instantaneous acoustic velocity.

18. The system of claim 12, further comprising:
a spectral whitener for flattening a spectrum of said distorted signal,
wherein the spectral whitener receives said distorted signal from a non-linear estimator and provides a whitened signal to an input of said echo suppressor.

19. The system of claim 12, wherein said first non-linear estimator and said second non-linear estimator receive a convergence error from said echo canceller and adapt using a gradient search algorithm.

20. The system of claim 11, further comprising:
a sensor coupled to said transducer for physically measuring a cone displacement, wherein said displacement unit converts an input signal to a displacement signal using said cone displacement.
